(19) United States
(12) Patent Application Publication
(10) Pub. No.: US 2019/0168484 A1
(43) Pub. Date: Jun. 6, 2019

(54) COMPOSITE PANEL AND METHOD OF FORMING SAME

(71) Applicant: CORRUVEN CANADA INC., Kedgwick (CA)

(72) Inventors: Alain BELANGER, Kedgwick (CA); Daniel BEAUREGARD-LONG, Edmundston (CA); Scott PHILIPPE, St-Joseph (CA); Christian JALBERT, St-Jacques (CA)

(73) Assignee: CORRUVEN CANADA INC.

(21) Appl. No.: 16/259,217

(22) Filed: Jan. 28, 2019

Related U.S. Application Data
(63) Continuation of application No. PCT/CA2017/050888, filed on Jul. 25, 2017.
(60) Provisional application No. 62/367,245, filed on Jul. 27, 2016.

(51) Int. Cl. B32B 7/12; B32B 21/14; B32B 21/06; B32B 29/08; B32B 29/02; B27D 1/06; B27D 1/08; E04C 2/16; E04C 2/32

(52) U.S. Cl. CPC B32B 7/12; B32B 21/14; B32B 21/06; B32B 29/08; B32B 2317/122; B27D 1/06; B27D 1/08; E04C 2/16; E04C 2/322; B32B 29/02

(57) ABSTRACT

A composite panel includes a sheet having layers. At least two of the layers are kraft paper. The layers re stacked on each other and adhered together with a resin. The sheet is corrugated with alternating peaks and valleys disposed sequentially along an axis of the sheet. Each peak has a plateau and each valley has a base. Each of the plateaus and the bases lies in a plane being substantially parallel to the axis of the one sheet.

### CROSS-REFERENCE TO RELATED APPLICATIONS

This application is a continuation of International Patent Application No. PCT/CA2017/050888 with a filing date of Jul. 25, 2017, designating the United States, now pending, and further claims priority to U.S. Provisional Application No. 62/367,245 with a filing date of Jul. 27, 2016. The content of the aforementioned applications, including any intervening amendments thereto, are incorporated herein by reference.

### TECHNICAL FIELD

The application relates generally to panels and, more particularly, to a composite panel and a method of forming same.

### BACKGROUND OF THE ART

Wood composites typically consist of one type of wood adhered to another type of wood to provide a structural and/or aesthetic product. Some conventional wood composites must have a certain minimum thickness to provide them with the requisite structural properties for their given application. This minimum thickness, however, makes them unsuitable for other applications which require a thinner wood composite. Furthermore, some wood composites do not sufficiently resist moisture on their own, and thus require relatively costly coatings, or relatively complicated moisture barriers, to make them suitable for a given application.

### SUMMARY

In one aspect, there is provide a composite panel, comprising: a sheet having layers, at least two of the layers being kraft paper, the layers being stacked on each other and adhered together with a resin, the sheet being corrugated with alternating peaks and valleys disposed sequentially along an axis of the sheet, each peak having a plateau and each valley having a base, each of the plateaus and the bases lying in a plane being substantially parallel to the axis of the one sheet.

In another aspect, there is provided a method of forming a structural composite panel, comprising: stacking layers and adhering the layers together to form a sheet, at least two of the layers being kraft paper; and corrugating the sheet along an axis to form alternating peaks and valleys disposed sequentially along the axis, each peak having a plateau and each valley having a base, each of the plateaus and the bases lying in a plane being substantially parallel to the axis of the sheet.

### DESCRIPTION OF THE DRAWINGS

Reference is now made to the accompanying figures in which:

FIG. 1A is a perspective view of multiple composite panels stacked together, according to an embodiment of the present disclosure;

FIG. 1B is a schematic side elevational view of part of one of the composite panels of FIG. 1A; and

FIG. 2 is a cross-sectional schematic view of part of a composite panel, according to another embodiment of the present disclosure.

### DETAILED DESCRIPTION

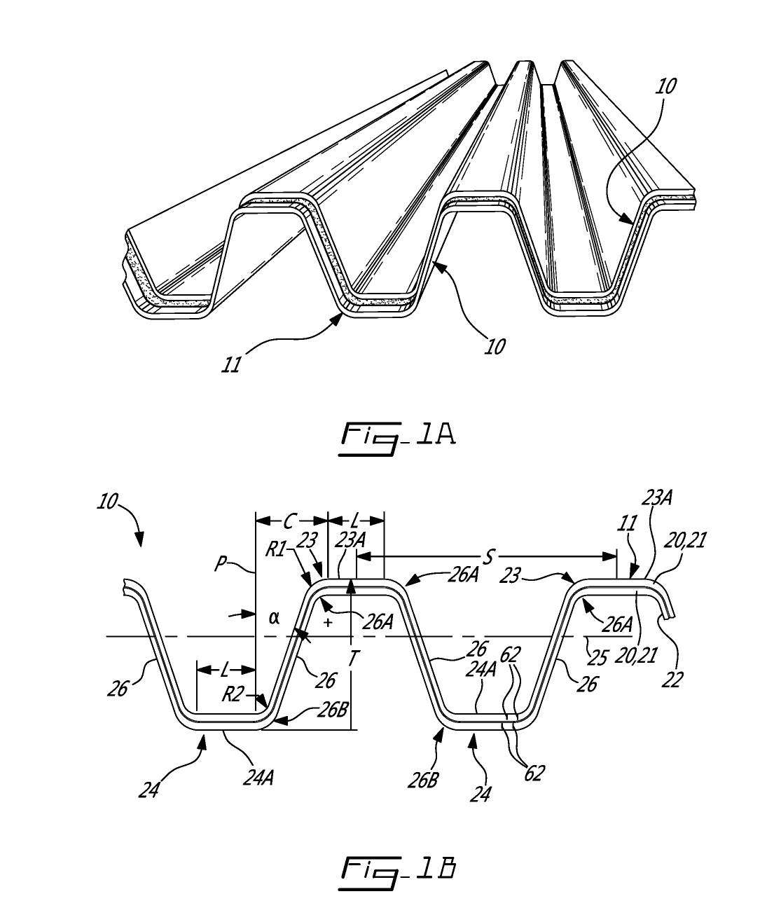

FIG. 1A illustrates a composite panel 10. More particularly, FIG. 1A shows multiple nested composite panels 10 stacked one on top of the other. In the depicted embodiment, the composite panel 10 includes a sheet 11 and is provided in sheet form. The entire sheet 11 is made up of the composite materials of the composite panel 10. The composite panel 10 can be used for structural applications, such as in flooring, walls, or panels, because it can support loads applied on either side of the sheet 11. In the depicted embodiment, the sheet 11 is corrugated. In an alternate embodiment, the sheet 11 has another undulated or wave-like shape. An outer surface of the composite panel 10 can have a finishing or lining to provide an aesthetically-pleasing appearance. As will be described in greater detail below, the composite panel 11 is a corrugated, thin, self-standing and self-supported structure made from relatively thin layers of materials.

Referring to FIG. 1B, the composite panel 10 is a stack-up of layers. More particularly, the sheet 11 includes multiple layers 20. Each of the layers 20 is stacked one against the other to form the structure of the sheet 11, and thus the structure of the composite panel 10. The superposition of the layers 20 may help the sheet 11 to better resist compressive forces. Two or more of the layers 20 are layers of kraft paper 21. Kraft paper, sometimes simply referred to as “kraft”, is any suitable paper or paperboard produced from pulp using the Kraft process. In the depicted embodiment, the sheet 11 includes only two layers 20. More particularly, the sheet 11 in FIG. 1B is composed only of two layers of kraft paper 21 which are stacked to abut against one another, and are adhered directly together with a resin 22. Alternate embodiments and constructions of the sheet 11 are within the scope of the present disclosure, and some of these are described in greater detail below.

The layers 20 are adhered together with the resin 22. The resin 22 can be any suitable compound or adhesive that is capable of such functionality. For example, the resin 22 can be a thermoset resin 22. Some non-limiting examples of resins 22 that can be used include poly(vinyl acetate) (PVAc), polymeric Methylene Diphenyl Diisocyanate (pMDI), phenol formaldehyde (PF), and Melamine Urea Formaldehyde (MUF). Any number of applications of resin 22, having any suitable thickness, can be applied to one or both of the surfaces of the layers 20. When the resin 22 is applied, one or both of the temperature and a humidity level of the resin 22 can be controlled. The pressure at which the resin 22 is applied may also be controlled. Furthermore, the temperature and pressure at which the resin 22 is applied can be optimised depending on a number of factors, such as the type of resin 22 being used, and the thickness of the layers 20.

The corrugated sheet 11 is shaped to have alternating peaks 23 and valleys 24 disposed sequentially along an axis 25 of the sheet 11. The axis 25 of the sheet 11 is the axis 25 along which the sheet 11 is corrugated. Along the axis 25 of the sheet 11, each peak 23 is immediately adjacent to a valley 24, which is immediately adjacent to another peak 23. It will be appreciated that the designation of peaks 23 and valleys 24 can be inverted, such that the peaks 23 become valleys 24 and vice versa when the sheet 11 is inverted.

Each peak 23 has a plateau 23A and each valley 24 has a base 24A. The plateau 23A includes the highest surface of the peak 23, and the base 24A includes the lowest surface of the valley 24. The plateaus 23A and the bases 24A are the portions of the sheet 11 spaced furthest from each other in a direction transverse to the axis 25. The plateaus 23A and the bases 24A are planar bodies. In the depicted embodiment, they are substantially flat members which lie in a plane that is substantially parallel to the axis 25. The corrugated sheet 11 also has intermediate segments 26 which extend between and interconnect the adjacent peaks 23 and valleys 24. One end of each intermediate segment 26 has a first joint portion 26A connecting the intermediate segment 26 to the plateau 23A. The other, opposite end of each intermediate segment 26 has a second joint portion 26B connecting the intermediate segment 26 to the base 24A. The flat plateaus 23A and flat bases 24A, in conjunction with the intermediate segments 26, provide the corrugated sheet 11 with a trapezoidal shape. The trapezoidal corrugation of the sheet 11 may help to better resist compressive forces. The trapezoidal corrugation of the sheet 11 allows facilitates the stacking or nesting of one sheet 11 over the other, as shown in FIG. 1A.

Possible dimensions for the corrugation of the composite panel 10 are now discussed in reference to FIG. 1B. Each plateau 23A and each base 24A has a length L defined along the axis 25 of the sheet 11 of about 11 mm or 0.43 in, with a variation on either side of 0.1 mm or 0.0039 in. The sheet 11 has a thickness T measured transverse to the axis 25 of the sheet 11. The thickness T in FIG. 1B is measured from an outer surface of one of the plateaus 23A to the outer surface of an adjacent base 24A. The thickness is about 19 mm or 0.75 in., with a variation on either side of 1 mm or 0.039 in. The thickness T of the panel 10 is therefore relatively small (i.e. less than 1 in.), and the panel 10 is therefore relatively thin. Adjacent plateaus 23A, and thus adjacent bases 24A, are separated by a distance S measured along the axis 25. The distance S is about 50 mm, with a variation on either side of 3 mm or 0.12 in.

Still referring to FIG. 1B, an axial distance C between the plateaus 23A and the bases 24A is defined. The distance C is a measure of the distance along the axis 25 separating the end of the bases 24A and the beginning of a neighbouring or adjacent plateau 23A. The distance C is similarly a measure of the distance separating the end of the plateaus 23A and the beginning of a neighbouring or adjacent base 24A. In FIG. 1B, the distance C is about 14 mm or 0.55 in, with a variation on either side of 0.5 mm or 0.020.

The first joint portion 26A of the intermediate segments 26 is curved and has a first radius of curvature R1. The second joint portion 26B is also curved and has a second radius of curvature R2. The intermediate segments 26 are therefore joined to the plateaus 23A and the bases 24A along curved portions 26A,26B. In the depicted embodiment, the first radius of curvature R1 is different than the second radius of curvature R2. More particularly, the first radius of curvature R1 is about 5.7°, with a variation on either side of 0.1°. The second radius of curvature R2 is about 3.1°, with a variation on either side of 0.1°. An angle of corrugation a is defined between a plane P being perpendicular to the axis 25 and each intermediate segment 26. The angle of corrugation a in FIG. 1B is constant such that the corrugation of the sheet 11 is the same along the axis 25. In an alternate embodiment, the angle of corrugation a varies between the peaks 23 and valleys 24, such that the corrugation of the sheet 11 changes along the axis 25. In the depicted embodiment, the angle of corrugation is about 26°, with a variation on either side of 1°.

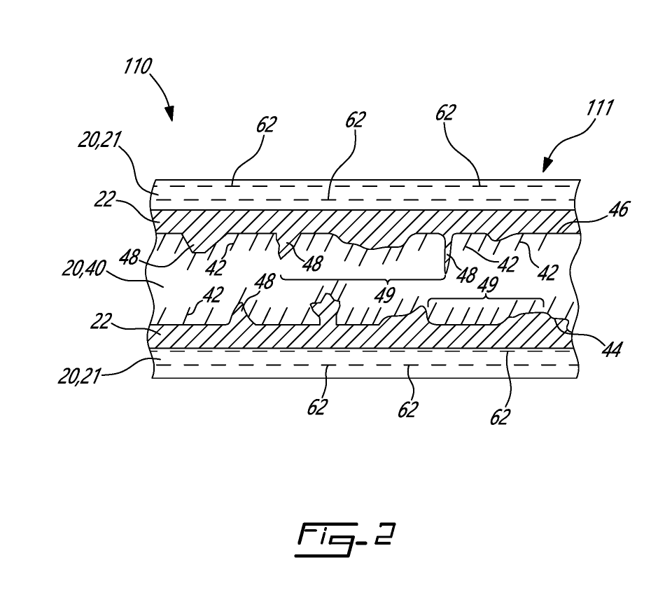

Part of another embodiment of the panel 110 is shown in FIG. 2. FIG. 2 shows a cross-section of part of the sheet 111 of the panel 110. The layers 20 of the sheet 111 include a layer of wood veneer 40. The wood veneer 40 may be made by “peeling” a circular wood log or by slicing large blocks of wood. Other techniques are possible. The type of wood used for the wood veneer 40 can vary. For example, where the wood veneer 40 will be visible and serve an aesthetic function, the wood used to make the wood veneer 40 can be a hardwood or a wood having a nice growth ring pattern. Similarly, where the wood veneer 40 will be hidden and serve a primarily structural function, a relatively inexpensive softwood can be used. It is observed that wood species with higher densities provide greater stiffness to the composite panel 110. The layers of wood veneer 40 are relatively thin, for example thinner than about 3 mm or 0.125 in.

The wood veneer 40 has wood fibers 42 or grains which have an orientation. The orientation of the wood fibers 42 may depend on the manner by which the layer of wood veneer 40 is made. For example, where the layer of wood veneer 40 is peeled from an elongated log, the wood fibers 42 will have an orientation being substantially parallel to the longitudinal axis of the log. It is observed that the wood veneer 40 provides a relatively stiff resistance to bending in the direction of the orientation of its wood fibers 42, while being relatively pliable in a direction that is transverse to the orientation of its wood fibers 42. It can thus be appreciated that the orientation of the wood fibers 42 can be selected to optimise bending and/or pliability along any desired direction. The wood veneer 40 can be provided so that the majority of its wood fibers 42 are substantially parallel to one another, and oriented in the same direction. For example, at least 70% of the wood fibers 42 of the wood veneer 40 can be oriented along one direction. This single direction can be parallel to the axis 25 of the sheet 111, or transverse thereto. In alternate embodiments, the layers 20 include more than one layer of wood veneer 40.

Each layer of wood veneer 40 has a first side 44 and a second side 46. The first and second sides 44,46 define exposed outer surfaces of the wood veneer 40 against which the resin 22 may be applied. While the first and second sides 44,46 define substantially continuous surfaces, the wood fibers 42 of the wood veneer 40 are not perfectly or uniformly distributed at the surfaces such that pores 48 may be formed at the surfaces. Stated differently, the pores 48 extend into the body of the wood veneer 40 from the surfaces defined by its first and second sides 44,46. The pores 48 collectively form a wood matrix 49 that extends at least partially into the body of the wood veneer 40 from each of its first and second sides 44,46. The resin 22 penetrates into the wood matrix 49 to seal the pores 48.

The resin 22 is applied to one, or both, of the first and second sides 44,46 of the wood veneer 40. The application of the resin 22 over the surfaces defined by the first and second sides 44,46 fills the pores 48 with the resin 22, which penetrates into the wood matrix 49. The resin 22 blocks the pores 48 and therefore seals them to prevent the ingress of moisture into the wood veneer 40.

Still referring to FIG. 2, the application of the resin 22 to one or both of the first and second sides 44,46 will depend at least in part on the desired configuration of the composite panel 10. For example, in the configuration where the composite panel 10 is made up of one layer of wood veneer 40 which is covered on one side with a layer of kraft paper 21 and exposed on the other, the resin 22 is applied to only one of the first and second sides 44,46. In the depicted embodiment of FIG. 2 where the composite panel 10 is made up of one layer of wood veneer 40 which is covered on both sides with kraft paper 21, the resin 22 is applied to both the first and second sides 44,46, and the kraft paper 21 is applied over the resin-filled pores 48 of each of the first and second sides 44,46. The layers of kraft paper 21 in this configuration are indirectly adhered together via the core layer of wood veneer 40.

In the configuration where the composite panel 10 is made up of two abutting wood veneers 40 covered on their exposed surfaces by liners, the resin 22 is applied to both the first and second sides 44,46 of the first wood veneer 40, the kraft paper 21 is applied over the resin-filled pores 48 of one of the first and second sides 44,46 of the first wood veneer 40, the second wood veneer 40 is applied over the resin-filled pores 48 of the other side 44,46 of the first wood veneer 40, the resin 22 is applied to the free side of the second wood veneer 40, and another layer of kraft paper 21 is applied over the resin 22 of the free side of the second wood veneer 40 to adhere the second kraft paper 21 to the free side of the second wood veneer 40. It is therefore possible to form many configurations of the composite panel 10 including, but not limited to, liner-resin-liner (i.e. kraft paper-resin-kraft paper), liner-resin-veneer-resin-liner, and liner-resin-veneer-resin-veneer-liner. In an alternate embodiment, the liner is a polymer film or sheet.

It can thus be appreciated that the resin 22 and its parameters of application can be optimised to encourage “polymerisation” with the wood veneer 40, a process similar to the chemical reaction by which monomer molecules react together to form polymer chains. Stated differently, the resin 22 becomes embedded at depth in the wood matrix 49 of the wood veneer 40 such that, when the resin 22 is cured, the resin 22 and wood veneer 40 are integral with one another. The resin 22 therefore both seals the pores 48 of the wood matrix 49, and serves as an adhesive to strongly bind the kraft paper 21 to the wood veneer 40.

In the depicted embodiment, in which the liner is a layer of kraft paper 21, the kraft paper 21 contributes to the strength of the composite panel 110. The kraft paper 21 has paper fibers 62, the majority of which are oriented along the same direction. In the depicted embodiment, the paper fibers 62 are oriented substantially transverse to the orientation of the wood fibers 42 (which are shown being oriented into the page). It can thus be appreciated that the kraft paper 21, once adhered to the wood veneer 40 via the resin 22, helps to reinforce the strength of the composite panel 110, particularly in the direction along which the paper fibers 62 are oriented. In such a configuration, the kraft paper 21 reinforces the composite wood material 30 in a direction that is transverse to the orientation of the wood fibers 42. This is desirable because the composite panel 10 is expected to have the least amount of mechanical resistance in the direction transverse to the wood fibers 42. The kraft paper 21 therefore allows the wood fibers 42 to be linked across the grain direction of the wood veneer 40. In embodiments where the kraft paper 21 has a relatively high tensile strength, it contributes to the overall strength of the composite panel 110.

The orientation of the paper fibers 62 of the layers of kraft paper 21 may also contribute to the overall strength of the composite panel 10 in FIGS. 1A and 1B. In the depicted embodiment where the composite panel 10 includes only two layers of kraft paper 21, a majority of the paper fibers 62 are aligned in a direction transverse to the axis 25 of the sheet 11. In the depicted embodiment, the paper fibers 62 are shown being oriented into the page, and only a representative sample of all the paper fibers 62 is shown. (Inventeurs: merci de nous indiquer le pourcentage des fibres qui sont orientés perpendiculaires à la corrugation)

Examples of layers of kraft paper 21, and their thickness and weight, are now discussed. One possible material for the layers of kraft paper 21 includes Chipboard 20 pts. The thickness of a single layer of Chipboard 20 pts. is 0.51 mm or 0.02 in. An embodiment of the composite panel 10 having only two layers of Chipboard 20 pts. adhered together with the resin 22 provided a thickness of 0.97 mm or 0.04 in, and a weight of 99.1 g/ft². Another possible material for the layers of kraft paper 21 includes Chipboard 30 pts. The thickness of a single layer of Chipboard 30 pts. is 0.75 mm or 0.03 in. An embodiment of the composite panel 10 having only two layers of Chipboard 30 pts. adhered together with the resin 22 provided a thickness of 1.59 mm or 0.06 in, and a weight of 137.1 g/ft². An embodiment of the composite panel 110 having two layers of paper liner 21 adhered to a core layer of wood veneer 40, as shown in FIG. 2, provided a thickness of 1.18 mm or 0.045 in.

Testing was performed on embodiments of the composite panel 10,110 of the present disclosure, and the results are now described in greater detail. Table 1 below presents the results of testing to determine the modulus of elasticity (MOE), the edgewise compression strength (ECT), and the flat crush test (FCT) for a composite panel 10 having only two layers of kraft paper 21, of either Chipboard 20 pts. or the thicker Chipboard 20 pts., adhered together with the resin 22.

TABLE 1
Composite Panel Having only Two Paper Layers

| | Chipboard 20 | Chipboard 30 |
|---|---|---|
| MOE (ASTM D 1037 | 145 | 200 |
| adapted) (MPa) | | |
| Edgewise Compressive | 17.5 | 23.5 |
| Strength (ECT) (N/mm) | | |
| Flat Crush Test | 41 | 96 |
| (FCT) (KPa) | | |

Table 1 reveals that by increasing the thickness of each layer of kraft paper 21 by about 0.25 mm or 0.01 in., a relatively small amount, improvements in MOE, ECT, and FCT are obtained.

Table 2 below presents the results of testing to determine the MOE, the ECT, and the FCT for a composite panel 110 having two layers of kraft paper 21 adhered to a central core layer of wood veneer 40. In the middle column, the kraft paper 21 is 28 lb medium and the wood veneer is 0.8 mm thick BassWood. In the right column, the kraft paper 21 is Chipboard 30 pts. and the wood veneer is 0.8 mm thick BassWood. Thus the only difference between the two constructions of the composite panel 110 is the layer of kraft paper 21.

TABLE 2
Composite Panel Having Two Paper
Layers and Wood Veneer Core

| | 28 lb medium, | Chipboard 30, |
|---|---|---|
| | 0.8 mm thick | 0.8 mm thick |
| | BassWood | BassWood |
| MOE modulus of | 730 | 1030 |
| elasticity (ASTM D | | |
| 1037 adapted) (MPa) | | |
| Edgewise Compressive | 74 | 96 |
| Strength (ECT) (N/mm) | | |
| Flat Crush Test | 60 | 158 |
| (FCT) (KPa) | | |

Table 2 reveals that by increasing the thickness of each layer of kraft paper 21 by a relatively small amount, improvements in MOE, ECT, and FCT are obtained. Indeed, the FCT, which is a measure of the resistance of the composite panel 110 to compression, and thus a measure of the structural strength of the composite panel 110, more than doubles.

Table 3 below presents the results of testing to determine the MOE, the ECT, and the FCT for another composite panel 110 having two layers of 28 lb medium kraft paper 21 adhered to a central core layer of wood veneer 40. In the middle column, the wood veneer is 0.6 mm thick BassWood. In the right column, the wood veneer is 0.7 mm thick Birch Wood. Thus the only difference between the two constructions of the composite panel 110 is the core layer of wood veneer 40.

TABLE 3
Composite Panel Having Two Paper
Layers and Wood Veneer Core

| | 28 lb medium, | 28 lb medium, |
|---|---|---|
| | 0.6 mm thick | 0.7 mm thick |
| | BassWood | Birch Wood |
| MOE (ASTM D 1037 | 960 | 1370 |
| adapted) (MPa) | | |
| Edgewise Compressive | 126 | 173 |
| Strength (ECT) (N/mm) | | |
| Flat Crush Test | 131 | 170 |
| (FCT) (KPa) | | |

Table 3 reveals that by increasing the thickness of the core layer of wood veneer 40 by a relatively small amount (i.e. 0.1 mm or 0.004 in.), improvements in MOE, ECT, and FCT are obtained.

Table 4 below illustrates the effect of adding a core layer of wood veneer 40 between two layers of kraft paper 21. Table 4 below presents the results of testing to determine the MOE, the ECT, and the FCT for i) a composite panel 10 having only two layers of kraft paper 21 of Chipboard 30 pts. (middle column), and ii) a composite panel 110 having two layers of kraft paper 21 of Chipboard 30 pts. adhered to a central core layer of wood veneer 40 of 0.8 mm thick BassWood (right column). Thus the only difference between the two constructions of the composite panel 10,110 is the core layer of wood veneer 40.

TABLE 4
Two Composite Panel Constructions

| | | CHIP 30, 0.8 mm |
|---|---|---|
| | CHIP 30 | thick BassWood |
| MOE (ASTM D 1037 | 200 | 1030 |
| adapted) (MPa) | | |
| Edgewise Compressive | 23.5 | 96 |
| Strength (ECT) (N/mm) | | |
| Flat Crush Test | 96 | 158 |
| (FCT) (KPa) | | |

Table 4 reveals that by providing a core layer of wood veneer 40 between two layers of kraft paper 21, and thus increasing the thickness of the composite panel 10,110 by a relatively small amount, improvements in MOE, ECT, and FCT are obtained. Indeed, the FCT, which is a measure of the resistance of the composite panel 10,110 to compression, and thus a measure of the structural strength of the composite panel 110, almost doubles. The MOE increases about fivefold, and the ECT increases more than fourfold.

Table 5 below illustrates the effect of adding different layers of kraft paper 21 to the same core layer of wood veneer 40. Table 5 below presents the results of testing to determine the MOE, the ECT, and the FCT for i) a composite panel 110 having only two layers of kraft paper 21 of 28 lb medium (middle column) adhered to a central core layer of wood veneer 40 of 0.8 mm thick BassWood, and ii) a composite panel 110 having two layers of kraft paper 21 of Chipboard 30 pts. adhered to a central core layer of wood veneer 40 of 0.8 mm thick BassWood (right column). Thus the only difference between the two constructions of the composite panel 110 is the type of kraft paper 21.

TABLE 5
Two Composite Panel Constructions

| | 28 lb medium, | CHIP 30, |
|---|---|---|
| | 0.8 mm thick | 0.8 mm thick |
| | BassWood | BassWood |
| MOE (ASTM D 1037 | 730 | 1030 |
| adapted) (MPa) | | |
| Edgewise Compressive | 74 | 96 |
| Strength (ECT) (N/mm) | | |
| Flat Crush Test | 60 | 158 |
| (FCT) (KPa) | | |

Table 5 reveals that by increasing the thickness of each layer of kraft paper 21 adhered to the same core layer of wood veneer 40 by a relatively small amount, improvements in MOE, ECT, and FCT are obtained. Indeed, the FCT, which is a measure of the resistance of the composite panel 110 to compression, and thus a measure of the structural strength of the composite panel 110, more than doubles.

Table 6 below illustrates the effect of changing the core layer of wood veneer 40 between two identical layers of kraft paper 21. Table 6 below presents the results of testing to determine the MOE, the ECT, and the FCT for i) a composite panel 110 having two layers of kraft paper 21 of 28 lb medium (middle column) adhered to a central core layer of wood veneer 40 of 0.6 mm thick BassWood, and ii) a composite panel 110 having two layers of kraft paper 21 of 28 lb medium adhered to a central core layer of wood veneer 40 of 0.7 mm thick Birch Wood (right column). Thus the only difference between the two constructions of the composite panel 110 is the type of wood species used for the core layer of wood veneer 40.

TABLE 6
Two Composite Panel Constructions

| | 28 lb medium, | 28 lb medium, |
|---|---|---|
| | 0.6 mm thick | 0.7 mm thick |
| | BassWood | Birch Wood |
| MOE (ASTM D 1037 | 960 | 1370 |
| adapted) (MPa) | | |
| Edgewise Compressive | 126 | 173 |
| Strength (ECT) (N/mm) | | |
| Flat Crush Test | 131 | 170 |
| (FCT) (KPa) | | |

Table 6 reveals that by changing the species of wood for the core layer of wood veneer 40 and by increasing the thickness of the core layer of wood veneer 40 by a relatively small amount, improvements in MOE, ECT, and FCT are obtained.

Referring to FIGS. 1A and 1B, there is disclosed a method of forming the structural composite panel 10,110. The method includes stacking the layers 20 and adhering the layers 20 together to form the sheet 11, where at least two of the layers 20 are layers of kraft paper 21. The method includes corrugating the sheet 11 along the axis 25 to form alternating peaks 23 and valleys 24 disposed sequentially along the axis 25. Each peak 23 has a plateau 23A and each valley 24 has a base 24A. Each of the plateaus 23A and the bases 24A lie in a plane being substantially parallel to the axis 25 of the sheet 11.

Referring to FIG. 2, the method also includes applying the kraft paper 21 over the resin-filled pores 48 of the wood matrix 49 to adhere the kraft paper 21 to a corresponding side 44,46 of the wood veneer 40. The kraft paper 21 can be any suitable material that seals the resin 22 between the kraft paper 21 and the corresponding side 44,46. In most embodiments, but not necessarily all, the kraft paper 21 will be in the form of a sheet of the material. The material of the kraft paper 21 can include, but is not limited to, paperboard, kraft paper. The kraft paper 21 can also be coloured or be printed upon to provide a desired surface finish to the composite panel 10,110.

The method also includes curing the resin 22 to form the composite panel 10,110. The step of curing can take many forms and will be largely dependent on the resin 22 being used. For example, some resins 22 can be air-cured, while others are cured through the application of heat. Pressure can also be applied to the liner-resin-wood veneer construction during the curing process. Once cured, the resin 22 is irreversibly linked with the wood veneer 40 and/or its wood fibers 42, as well as with the kraft paper 21.

It can thus be appreciated that the present disclosure relates to a composite panel 10, in one embodiment, having its primary structural properties provided by layers of kraft paper 21. The composite panel 10 is therefore a corrugated paper product that provides structural strength with relatively thin layers of paper.

It can be further appreciated that the present disclosure relates to a composite panel 110, which in one embodiment, having its primary structural properties provided by a wood veneer 40 core in combination with kraft paper 21. The penetration of the resin 22 into the wood matrix 49 allows for the formation of an integrated, rigid, and reinforced composite panel 110.

The possibility of controlling the orientation of the wood fibers 42, and thus controlling the direction of flexion of the composite panel 110, allows the composite panel 110 to be provided as a flat object, or a rolled sheet.

Indeed, the ability to provide both the wood veneer 40 and the kraft paper 21 in sheet form allows the composite panel 10,110 to be formed from a continuous fabrication process in which a sheet of the wood veneer 40 is displaced with rollers, the resin 22 is applied, and a sheet of the kraft paper 21 is placed onto the resin 22 using rollers and pressed thereagainst. Such a fabrication process is rapid and cost-effective.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

We claim:

1. A composite panel, comprising: a sheet having layers, at least two of the layers being kraft paper, the layers being stacked on each other and adhered together with a resin, the sheet being corrugated with alternating peaks and valleys disposed sequentially along an axis of the sheet, each peak having a plateau and each valley having a base, each of the plateaus and the bases lying in a plane being substantially parallel to the axis of the one sheet.

2. The composite panel as defined in claim 1, wherein the layers of the sheet include only two layers of kraft paper stacked one over the other and adhered directly together with the resin.

3. The composite panel as defined in claim 1, wherein the layers of the sheet include a layer of wood veneer having wood fibers defining a porous wood matrix extending into the wood veneer from each of a first and a second side of the wood veneer, the resin being applied to both of the first and second sides, the resin filling pores of the wood matrix, the layers of kraft paper at least partially covering both the first and second sides of the wood veneer and adhered thereto with the resin.

4. The composite panel as defined in claim 3, wherein a majority of the wood fibers of the layer of wood veneer are aligned along a single direction.

5. The composite panel as defined in claim 3, wherein each of the layers of kraft paper includes paper fibers, a majority of the paper fibers being oriented transverse to the wood fibers.

6. The composite panel as defined in claim 3, wherein each of the layers of the kraft paper have paper fibers, a majority of the paper fibers being aligned in a direction transverse to the axis of the sheet.

7. The composite panel as defined in claim 1, wherein each plateau and each base has a length defined along the axis of the sheet of about 11 mm.

8. The composite panel as defined in claim 1, wherein the sheet has a thickness measured transverse to the axis of the sheet, the thickness being about 19 mm.

9. The composite panel as defined in claim 1, wherein adjacent plateaus are separated by a distance measured along the axis of the sheet of about 50 mm.

10. The composite panel as defined in claim 1, wherein the sheet has intermediate segments interconnecting the peaks and valleys, each intermediate segment having a first joint portion at a first end thereof connected to one of the plateaus, and a second joint portion at a second end of the intermediate segment connected to one of the bases, the first joint portion being curved and having a first radius of curvature, the second joint portion being curved and having a second radius of curvature.

11. The composite panel as defined in claim 11, wherein the first radius of curvature is different than the second radius of curvature.

12. The composite panel as defined in claim 11, wherein the first radius of curvature is about 5.7° and the second radius of curvature is about 3.0°.

13. The composite panel as defined in claim 10, wherein an angle of corrugation is defined between a plane perpendicular to the axis of the sheet and each intermediate segment, the angle of corrugation being about 26°.

14. The composite panel as defined in claim 1, the panel being rolled up.

15. A method of forming a structural composite panel, comprising:
stacking layers and adhering the layers together to form a sheet, at least two of the layers being kraft paper; and
corrugating the sheet along an axis to form alternating peaks and valleys disposed sequentially along the axis, each peak having a plateau and each valley having a base, each of the plateaus and the bases lying in a plane being substantially parallel to the axis of the sheet.

16. The method as defined in claim 15, wherein stacking the layers includes stacking only the layers of kraft paper directly against each other and adhering them together.

17. The method as defined in claim 15, wherein stacking the layers includes stacking a layer of wood veneer having wood fibers between the layers of kraft paper adhered to both sides of the wood veneer.

18. The method as defined in claim 17, wherein stacking the layer of wood veneer includes orienting a majority of the wood fibers of the layer of wood veneer along a single direction.

19. The method as defined in claim 18, wherein stacking the layers includes orienting a majority of paper fibers of each of the layers of kraft paper transverse to the wood fibers.

20. The method as defined in claim 15, wherein stacking the layers includes orienting a majority of paper fibers of each of the layers of kraft paper in a direction transverse to the axis of the sheet.

21. The method as defined in claim 15, corrugating the sheet includes orienting segments connecting adjacent plateaus and bases at an angle of corrugation, the angle of corrugation being defined between a plane perpendicular to the axis and each segment, the angle of corrugation being about 26°.
